(19) United States
(12) Patent Application Publication
(10) Pub. No.: US 2014/0007008 A1
(43) Pub. Date: Jan. 2, 2014

(54) TECHNIQUES FOR SELECT-HOLD-RELEASE ELECTRONIC DEVICE NAVIGATION MENU SYSTEM

(71) Applicants: Jim S. Baca, Corrales, NM (US); Mubashir A. Mian, Santa Clara, CA (US); David Stanasolovich, Albuquerque, NM (US); Mark H. Price, Placitas, NM (US)

(72) Inventors: Jim S. Baca, Corrales, NM (US); Mubashir A. Mian, Santa Clara, CA (US); David Stanasolovich, Albuquerque, NM (US); Mark H. Price, Placitas, NM (US)

(21) Appl. No.: 13/977,089

(22) PCT Filed: Jun. 11, 2012
(86) PCT No.: PCT/US12/41919

§ 371 Date: Jun. 28, 2013

(51) Int. Cl. G06F 3/0482

(52) U.S. Cl. CPC G06F 3/0482
USPC 715/810

(57) ABSTRACT

A select-hold-release navigation system is described. An apparatus may comprise a select-hold-release navigation application operative on a processor circuit to present a navigation menu rotationally displaying one or more navigation elements based on user input received at the apparatus. The select-hold-release navigation application may be operative on the processor circuit to present a navigation menu rotationally displaying one or more navigation elements based on navigation input received at the apparatus, the navigation input comprising control directives generated by an input device coupled to the apparatus sustained for a defined duration and being associated with a navigation capable area. Other embodiments are described and claimed.

### BACKGROUND

Previous generations of computing devices were defined by their limitations, including restraints on accessibility, storage, available applications, and processing power. Users are now faced with different challenges that arise from the seemingly limitless functionality, data storage, and available applications of current devices. For instance, a user may no longer be concerned with having sufficient storage space for files, but may now be confronted with finding a way to efficiently and effectively access those files.

Mobile computing devices such as smart phones and tablet computing devices are not immune to these challenges. The popularity, flexibility, and ease of use of these devices has led to a proliferation of applications, “mobile apps” or “apps,” specifically developed for their operating systems and form factors. A typical mobile computing device may have dozens of mobile apps installed, in addition to settings, communications, and email applications that form the standard setup for such devices. For a typical user, the collection of mobile apps installed on their device is dynamic, changing often, even daily for active users. In general, mobile applications may be accessible from pages configured to display a certain number of mobile apps. It is customary for a mobile device to have many pages of mobile apps. In order to access a particular app, a user may have to go through multiple pages of mobile apps by scrolling through or otherwise manipulating the multiple pages. As a result, efficient access to device features and applications is becoming more and more difficult. As the number of mobile apps increases and users have longer relationships with their devices, this challenge will have an increasingly negative impact on user experiences with devices incorporating this technology.

It is with respect to these and other considerations that the present improvements have been needed.

### BRIEF DESCRIPTION OF THE DRAWINGS

FIG. 1 illustrates an embodiment of a select-hold-release navigation system.

FIG. 2 illustrates an embodiment of a first operating environment for a select-hold-release navigation application.

FIG. 3 illustrates an embodiment of a second operating environment for a select-hold-release navigation application.

FIG. 4 illustrates an embodiment of a third operating environment for a select-hold-release navigation application.

FIG. 5 illustrates an embodiment of a fourth operating environment for a select-hold-release navigation application.

FIG. 6 illustrates an embodiment of a fourth operating environment for a select-hold-release navigation application.

FIG. 7 illustrates an embodiment of a first logic flow.

FIG. 8 illustrates an embodiment of a second logic flow.

FIG. 9 illustrates an embodiment of a computing architecture.

FIG. 10 illustrates an embodiment of a communications architecture.

### DETAILED DESCRIPTION

Various embodiments are generally directed to techniques for displaying navigation menus configured to efficiently present electronic device elements, including applications and files. Some embodiments are particularly directed to select-hold-release navigation menus that are activated by user input received at the electronic device and sustained for a defined duration. According to certain embodiments, select-hold-release navigation generally involves navigation initiated by a user selection (“select”), wherein the navigation continues while the user maintains the input (“hold”), and one or more objects of navigation may be selected responsive to the user input being removed (“release”). In one embodiment, select-hold-release navigation may comprise receiving selection input at an electronic device, initiating navigation of electronic device elements responsive to the selection input being maintained for a defined duration, continuing navigation while the selection input is sustained, and selecting one or more of the electronic device elements responsive to a removal of the selection input. For example, a user may contact an object, such as a human finger, with a touch screen input device for a defined duration to initiate a navigation menu for navigating through applications installed on an electronic device that is coupled with the touch screen input device. The user may maintain the contact to navigate through the applications and may remove the contact to select one or more of the applications.

The select-hold-release navigation menus may be configured to display electronic device elements as rotating on the display, for example, in an area proximate to the sustained user input. The select-hold-release navigation menu may rotate through the navigation elements that are the focus of the navigation, displaying a subset of the navigation elements at any given time. With each rotational interval, the select-hold-release navigation menu may interchange the displayed navigation elements with other navigation elements according to an ordering structure (e.g., alphabetical, most recently used, date modified or created). In this manner, each navigation element may be presented to a user as part of the rotating display presented by the select-hold-release navigation menu. As a result, a user may efficiently access navigation elements, especially large sets of navigation elements, through a simple and more effective process requiring only one input gesture. This significantly reduces manual intervention needed by a user to locate and access computing device elements, thereby enhancing user productivity, convenience, and experience.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter

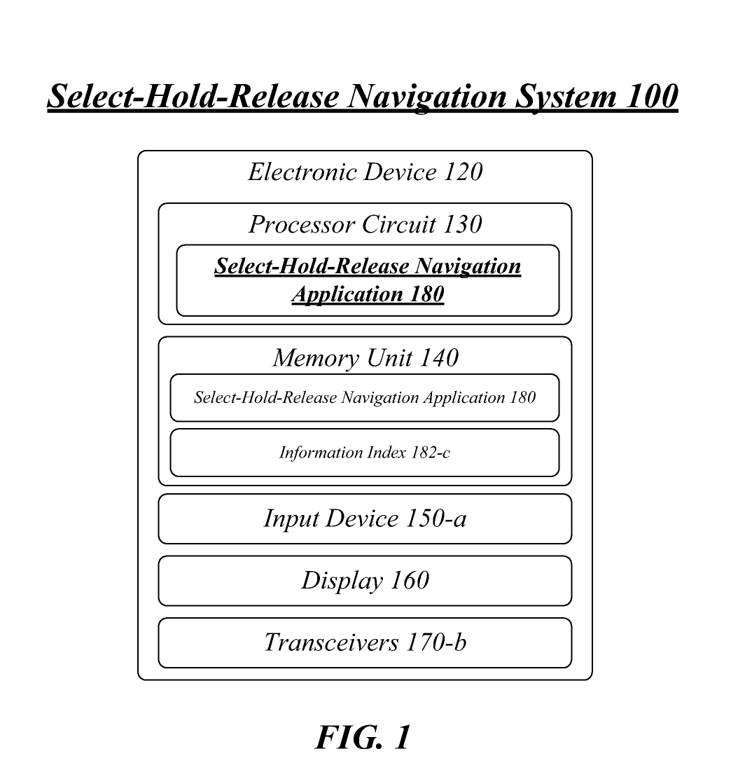

FIG. 1 illustrates a block diagram for a select-hold-release navigation system 100. In one embodiment, the select-hold-release navigation system 100 may comprise a computer-based system comprising an electronic device 120. The electronic device 120 may comprise, for example, a processor circuit 130, a memory unit 140, an input device 150-a, a display 160, and one or more transceivers 170-b. The electronic device 120 may further have installed a select-hold-release navigation application 180. The memory unit 140 may store an unexecuted version of the select-hold-release navigation application 180 and one or more information indexes 182-c. Although the select-hold-release navigation system 100 shown in FIG. 1 has a limited number of elements in a certain topology, it may be appreciated that the select-hold-release navigation system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of input devices 150 may include input devices 150-1, 150-2, 150-3, 150-4 and 150-5. The embodiments are not limited in this context.

In various embodiments, the select-hold-release navigation system 100 may comprise an electronic device 120. Some examples of an electronic device may include without limitation an ultra-mobile device, a mobile device, a personal digital assistant (PDA), a mobile computing device, a smart phone, a telephone, a digital telephone, a cellular telephone, electronic readers (e.g., eBook readers, e-readers, etc.), a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In various embodiments, the select-hold-release navigation system 100 may comprise a processor circuit 130. The processing processor circuit 130 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processor circuit 130.

In various embodiments, the select-hold-release navigation system 100 may comprise a memory unit 140. The memory unit 140 may store, among other types of information, the select-hold-release navigation application 180 and one or more information indexes 182-c. The memory unit 140 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

An information index 182-c may comprise any defined set of electronic information, data or content capable of being uniquely identified, presented by a user interface view, or represented by a user interface element of a user interface view. Exemplary information indexes 182-c may include, but are not limited to, files, records, registries, or other electronic storage structures comprising information pertaining to applications installed on an electronic device 120, playlists, contacts, folders, and files, including application files (e.g., document files, word processing files, spreadsheet files, presentation files, etc.), system files (e.g., operating system files, library files, utility files, etc.), and multimedia content files (e.g., audio files, video files, audio/video files, picture files, image files, etc.). These are merely a few examples, and any type of defined set of electronic information, data or content may be included in an information index 182-c. The embodiments are not limited in this context.

The electronic device 120 may implement or include one or more input devices 150-a for receiving user input. Exemplary input devices 150-a include, without limitation, touch screens, mouse input devices, track pads, touch pads, track balls, keyboards, pointing devices, combinations thereof, and other devices capable of communicating user input to the electronic device 120. In response to receiving user input, an input device 150-a may operate to generate one or more control directives, which may be communicated to or otherwise accessible by the select-hold-release navigation application 180 and other components of the electronic device 120. For example, user contact with a touch screen input device, such as contact using a human-finger, may invoke the touch screen input device to generate control directives comprised of input information, such as the location of the contact. The control directives may be used by an operating system or application as a directive to make a selection or to perform a function, including selecting an object, opening a file, opening an application, and opening a menu. An electronic device 120 may be coupled to multiple input devices 150-a at the same time. For instance, an electronic device 120 having a tablet computing device form factor may be designed to utilize a touch screen input device as the primary device for accepting user input, but may also be coupled to a mouse and keyboard input devices.

The electronic device 120 may implement a display 160. The display 160 may comprise any digital display device suitable for the electronic device 120. For instance, the display 160 may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, an electronic ink (E-ink) display, or other type of suitable visual interface for displaying content to a user of the electronic device 120. The display 160 may further include some form of a backlight or brightness emitter as desired for a given implementation.

In various embodiments, the computing device 120 may comprise one or more transceivers 170-b. Each of the transceivers 170-b may be implemented as wired transceivers, wireless transceivers, or a combination of both. In some embodiments, the transceivers 170-b may be implemented as physical wireless adapters or virtual wireless adapters, sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The transceivers 170-b may comprise or implement various communication techniques to allow the computing device 120 to communicate with other electronic devices. For instance, the transceivers 170-b may implement various types of standard communication elements designed to be interoperable with a network, such as one or more communications interfaces, network interfaces, NICs, radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the computing device 120 may implement different types of transceivers 170-b. Each of the transceivers 170-b may implement or utilize a same or different set of communication parameters to communicate information between various electronic devices. In one embodiment, for example, each of the transceivers 170-b may implement or utilize a different set of communication parameters to communicate information between the computing device 120 and one or more remote devices. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the transceivers 170-b. The embodiments are not limited in this context.

In one embodiment, for example, the transceiver 170-b may comprise a radio designed to communicate information over a wireless local area network (WLAN), a wireless metropolitan area network (WMAN), a wireless wide area network (WWAN), or a cellular radiotelephone system. The transceiver 170-b may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the transceiver 170-b may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

In various embodiments, the wireless transceivers 170-b may implement different communication parameters offering varying bandwidths, communications speeds, or transmission range. For instance, a first wireless transceiver 170-1 may comprise a short-range interface implementing suitable communication parameters for shorter range communications of information, while a second wireless transceiver 170-2 may comprise a long-range interface implementing suitable communication parameters for longer range communications of information.

In various embodiments, the terms “short-range” and “long-range” may be relative terms referring to associated communications ranges (or distances) for associated wireless transceivers 170-b as compared to each other rather than an objective standard. In one embodiment, for example, the term “short-range” may refer to a communications range or distance for the first wireless transceiver 170-1 that is shorter than a communications range or distance for another wireless transceiver 170-b implemented for the electronic device 120, such as a second wireless transceiver 170-2. Similarly, the term “long-range” may refer to a communications range or distance for the second wireless transceiver 170-2 that is longer than a communications range or distance for another transceiver 170-b implemented for the electronic device 120, such as the first wireless transceiver 170-1. The embodiments are not limited in this context.

In various embodiments, the terms “short-range” and “long-range” may be relative terms referring to associated communications ranges (or distances) for associated wireless transceivers 170-b as compared to an objective measure, such as provided by a communications standard, protocol or interface. In one embodiment, for example, the term “short-range” may refer to a communications range or distance for the first wireless transceiver 170-1 that is shorter than 300 meters or some other defined distance. Similarly, the term “long-range” may refer to a communications range or distance for the second wireless transceiver 170-2 that is longer than 300 meters or some other defined distance. The embodiments are not limited in this context.

In one embodiment, for example, the wireless transceiver 170-1 may comprise a radio designed to communicate information over a wireless personal area network (WPAN) or a wireless local area network (WLAN). The wireless transceiver 170-1 may be arranged to provide data communications functionality in accordance with different types of lower range wireless network systems or protocols. Examples of suitable WPAN systems offering lower range data communication services may include a Bluetooth system as defined by the Bluetooth Special Interest Group, an infra-red (IR) system, an Institute of Electrical and Electronics Engineers (IEEE) 802.15 system, a DASII7 system, wireless universal serial bus (USB), wireless high-definition (HD), an ultra-side band (UWB) system, and similar systems. Examples of suitable WLAN systems offering lower range data communications services may include the IEEE 802.xx series of protocols, such as the IEEE 802.11a/b/g/n series of standard protocols and variants (also referred to as “WiFi”). It may be appreciated that other wireless techniques may be implemented, and the embodiments are not limited in this context.

In one embodiment, for example, the wireless transceiver 170-2 may comprise a radio designed to communicate information over a wireless local area network (WLAN), a wireless metropolitan area network (WMAN), a wireless wide area network (WWAN), or a cellular radiotelephone system. The wireless transceiver 180-2 may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the wireless transceiver 170-2 may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

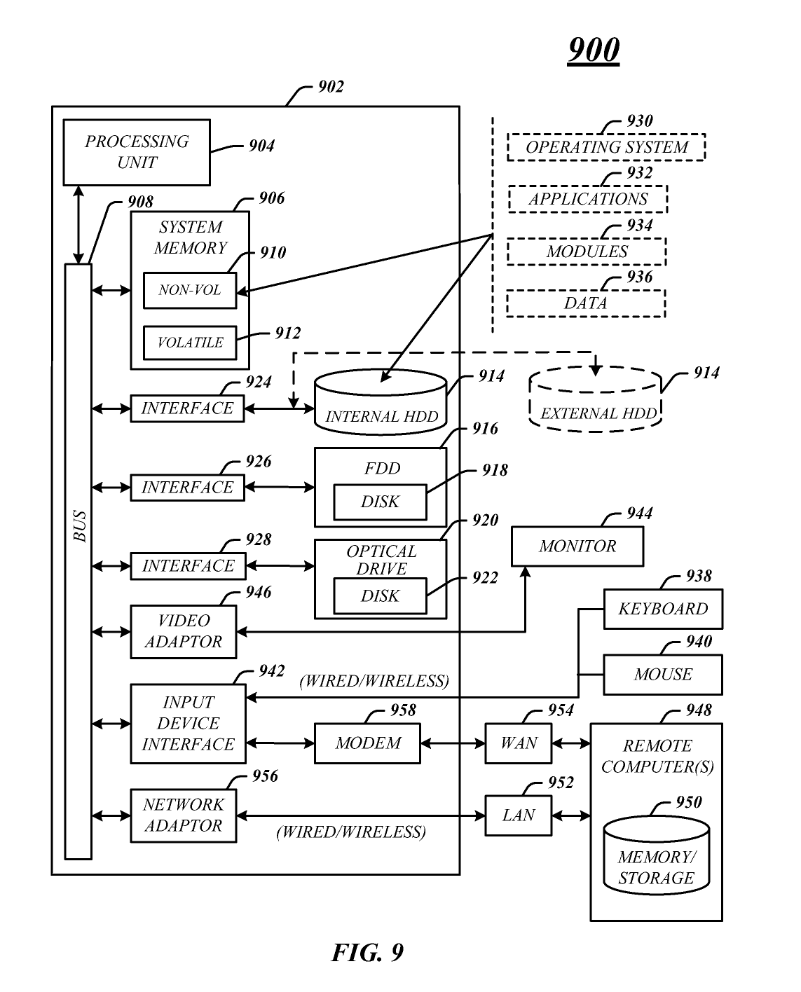

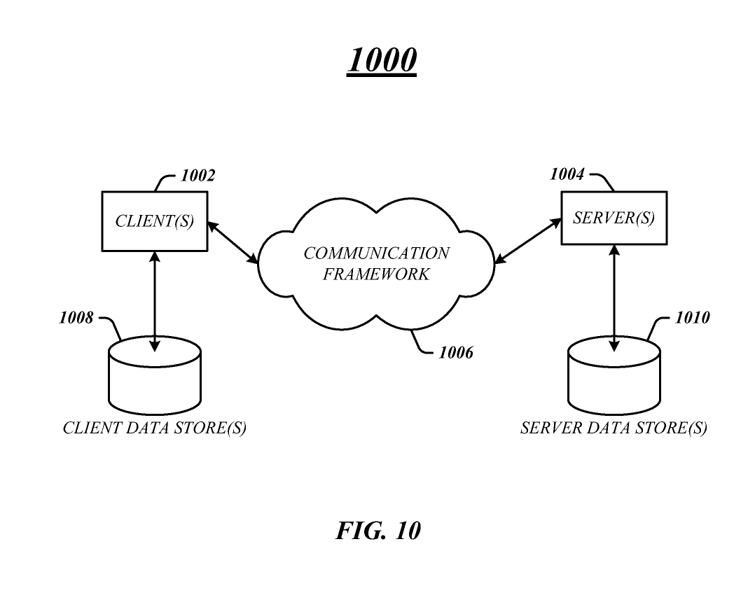

Although not shown, the electronic device 120 may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIGS. 9 and 10. The embodiments, however, are not limited to these examples.

In the illustrated embodiment shown in FIG. 1, the processor circuit 130 may be communicatively coupled to the input device 150-a, wireless transceivers 170-b, and the memory unit 140. The memory unit 140 may store a select-hold-release navigation application 180 arranged for execution by the processor circuit 130 to present a select-hold-release navigation menu configured to display electronic device elements for selection by a user of the electronic device 120.

The select-hold-release navigation application 180 may generally provide features to determine navigation input, or select-hold-release navigation input, received at the input device 150-a, determine a focus of navigation, present navigation elements associated with the focus of navigation while the navigation input is being maintained, and select one or more navigation elements responsive to the navigation input being removed. In one embodiment, navigation input may comprise user input received in a designated user interface area which is sustained for a defined duration (e.g., 0.5-5 seconds). In this manner, a user may look through, browse or otherwise interact with electronic device elements using nothing more than a single gesture, thereby substantially reducing manual intervention for locating and accessing electronic device elements, such as applications, files, and contacts. The defined duration is not limited to any range or specific value, as any ranges or values described herein are provided solely for illustrative and non-restrictive purposes. According to certain embodiments, the defined duration may be configured by a user to any defined value supported by the electronic device 120. Embodiments are not limited in this context.

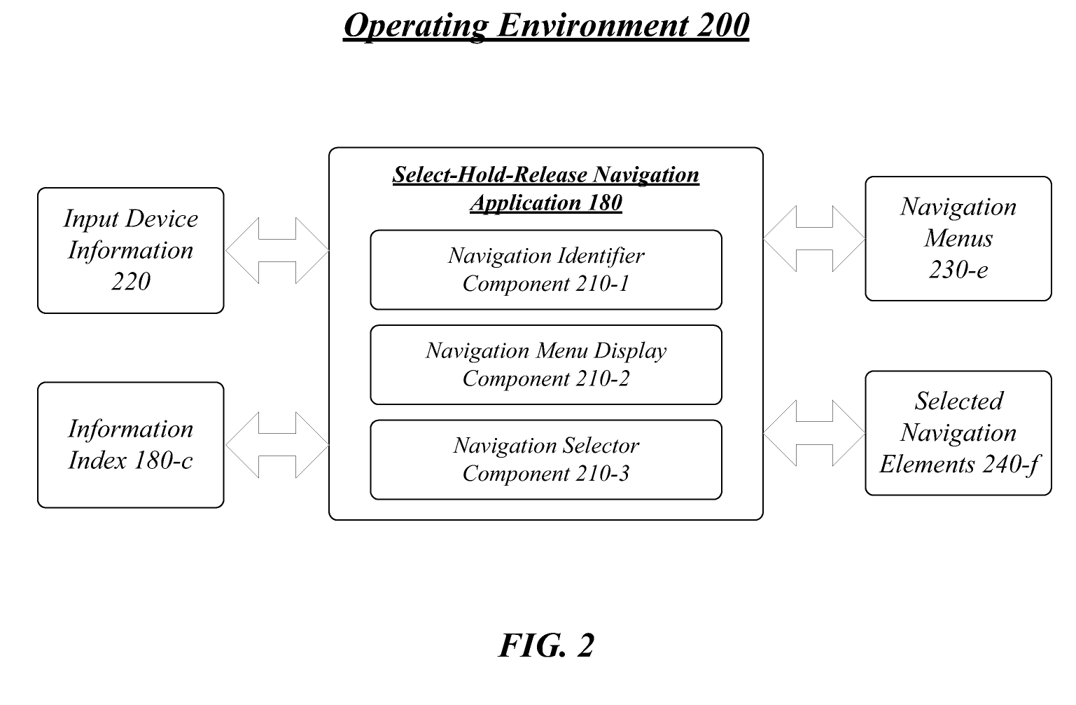

Particular aspects, embodiments and alternatives of the select-hold-release navigation system 100 and the select-hold-release navigation application 180 may be further described with reference to FIG. 2.

FIG. 2 illustrates an embodiment of an operating environment 200 for the select-hold-release navigation system 100. More particularly, the operating environment 200 may illustrate a more detailed block diagram for the select-hold-release navigation application 180.

As shown in FIG. 2, the select-hold-release navigation application 180 may comprise various components 210-d. As used in this application, the term “component” is intended to refer to a computer-related entity, either hardware, a combination of hardware and software, software, or software in execution. For example, a component can be, but is not limited to being, a process running on a processor, a processor circuit, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 2, the select-hold-release navigation application 180 may comprise a navigation identifier component 210-1, a navigation menu display component 210-2, and a navigation selector component 210-3. Although the select-hold-release navigation application 180 shown in FIG. 2 has only three components in a certain topology, it may be appreciated that the select-hold-release navigation application 180 may include more or less components in alternate topologies as desired for a given implementation. The embodiments are not limited in this context.

The navigation identifier component 210-1 may generally monitor input device information 220 to determine whether the input device information 220 is indicative of navigation input and, responsive to navigation input, identify a focus of the select-hold-release navigation. Input device information 220 may comprise user input received at the computing device 120 through one or more input devices 150-a. In one embodiment, input device information 220 may indicate select-hold-release navigation if user input is received in a designated user interface area and is sustained for a configurable, defined duration (e.g., 0.5-7 seconds). For example, select-hold-release navigation may be triggered if a user contacts one or more defined areas of a user interface being displayed on a touch screen input device of a tablet computing device for longer than one second. In one embodiment, a defined area may comprise an empty area of the user interface (e.g., an area devoid of application icons, shortcuts, etc.) In another example, navigation input may be indicated if a user selects a select-hold-release navigation capable object (e.g., icon, folder, button, application) with a mouse pointer coupled to a personal computer (PC) for at least two seconds. In one embodiment, input device information may comprise secondary input occurring while the select-hold-release navigation is being maintained. For instance, if the navigation input comprises user contact with a touch screen input device with a finger, secondary input may include user contact with the touch screen input device using a second finger. According to embodiments, additional select-hold-release navigation menu 230-e functionality may be invoked responsive to the presence of secondary input, as described in more detail below.

Responsive to receiving navigation input, the navigation identifier component 210-1 may be operative to identify a focus of the select-hold-release navigation. According to embodiments, the select-hold-release navigation application 180, operating systems, applications, user interfaces, or a combination thereof may be configured to operate with select-hold-release navigation as described herein. In one embodiment, certain areas, such as certain defined areas, of a user interface accessible from the display 160 of an electronic device 120 may be associated with select-hold-release navigation. For example, “empty” areas of a user interface that are devoid of application icons, menus, task bars, and the like may be configured to focus select-hold-release navigation on applications installed on the electronic device 120. In another example, an application may be configured such that certain application elements may focus select-hold-release navigation on certain aspects of the application, such as a “Contacts” button of an email application focusing select-hold-release navigation on email contacts. Embodiments provide that the defined areas may be configured in the select-hold-release navigation application 180, an electronic device 120 setting application, operating system, or some combination thereof.

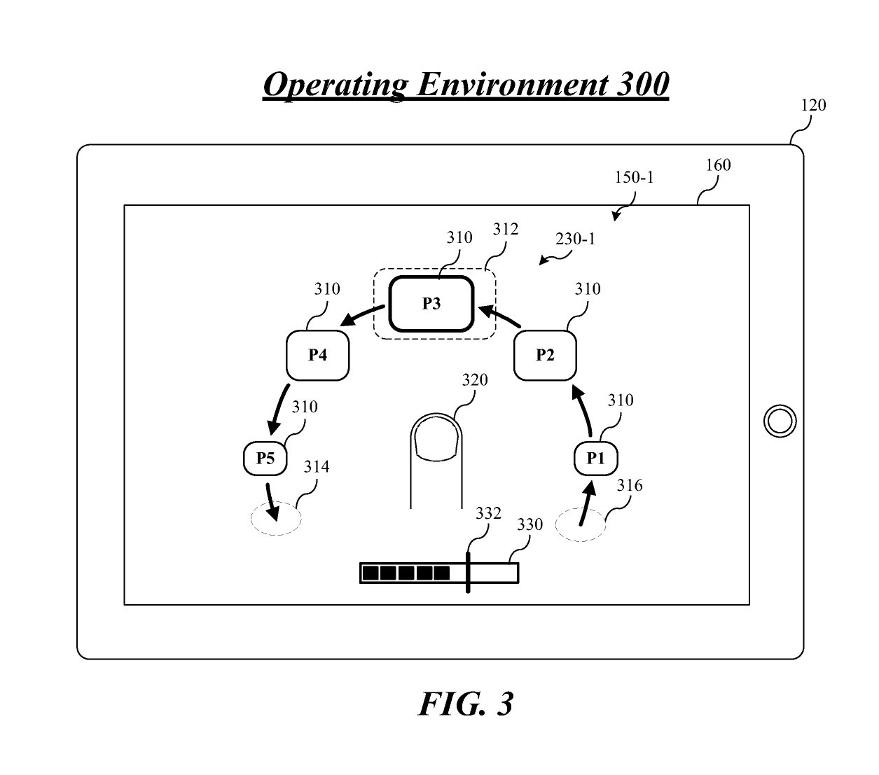

The navigation menu display component 210-2 may generally operate to present a select-hold-release navigation menu 230-e displaying the navigation elements associated with the navigation focus identified by the navigation identifier component 210-1. The select-hold-release navigation menu 230-e may be a graphical user interface component configured to display navigation elements associated with the navigation focus. In one embodiment, if the number of navigation elements is below a threshold amount (e.g., three to ten elements), then all of the navigation elements may be displayed and may rotate or not rotate about the area of navigation input, depending on the configuration of the select-hold-release navigation application 180. In another embodiment, the select-hold-release navigation menu 230-e may only display a subset of the navigation elements at any given time, where, with each rotational interval, the select-hold-release navigation menu 230-e may interchange one or more of the displayed navigation elements with one or more navigation elements not being displayed. For example, the rotational operation of the select-hold-release navigation menu 230-e may give the appearance that navigation elements are rotating up to the user interface, around the area of navigation input, and back down into the user interface, essentially forming a virtual vortex appearing to move in and out of the display device. In one embodiment, select-hold-release navigation menu 230-e may be accompanied by audio, for example, to further distinguish the user experience of select-hold-release navigation. The operation of the select-hold-release navigation menu 230-e is described in more detail with respect to FIG. 3, below.

The navigation menu display component 210-2 may differentially present the select-hold-release navigation menu 230-e responsive to secondary input received as input device information 220 at the navigation identifier component 210-1. Non-restrictive and illustrative examples of navigation menu display component 210-2 responses to secondary contact include shifting the focus of navigation, changing the ordering of navigation elements, reversing the direction of rotation, modifying the speed of rotation, stopping rotation, and activating active elements while continuing rotation. According to various embodiments, the select-hold-release navigation application 180 may have one or more configuration settings associated with different types of secondary input that specify responses to received secondary input. In one embodiment, the navigation elements may be segmented into one or more categories (e.g., utilities, games, and productivity applications) or tiers (e.g., based on frequency of use, most recently used, or user assigned levels) specified, for example, by the user or automatically by the select-hold-release navigation application 180. As such, the select-hold-release navigation application 180 may be configured to switch between categories or tiers in response to secondary input. In one embodiment, wherein the navigation input comprises a user contacting a touch screen input device with a finger, secondary input may be in the form of a second finger contacting the touch screen interface. For example, a first tap by the second finger may stop the rotation of elements by the select-hold-release navigation menu 230, while a second tap may reverse the direction of rotation.

According to some embodiments, the navigation elements displayed by the navigation menu display component 210-2 may be obtained from one or more information indexes 182-c. For example, if the focus of navigation is the applications installed on an electronic device 120, then the information index may comprise a registry file, playlist, or other data source containing application information, such as application names, icons, executable files, or combinations thereof. In one embodiment, the select-hold-release navigation application 180 may generate one or more information indexes 182-c for use with each focus of navigation, for example, through user input or an automated analysis of elements that should be associated with a particular focus of navigation.

The navigation selector component 210-3 may generally operate to select one or more navigation elements being displayed by the select-hold-release navigation menu 230-e responsive to a release of the navigation input. In one embodiment, selection comprises maintaining the display of the navigation elements being displayed when the navigation input is terminated. A user may then select one of the displayed navigation elements. In another embodiment, one of the displayed navigation elements may be designated as an active element, for example, by being highlighted, surrounded by a border, enlarged, simulated backlighting, or through other graphical elements that operate to distinguish the active element. As the navigation elements rotate, the active element may change. For instance, if the navigation elements rotate in a circular manner, the navigation element located at the topmost position may be designated as the active element. The release of the navigation input may initiate the active element without further input by the user.

FIG. 3 illustrates an embodiment of an operating environment 300 for the select-hold-release navigation system 100. More particularly, the operating environment 300 may illustrate a select-hold-release navigation menu 230-e presented on the display 160 of an electronic device 120.

In the illustrated embodiment shown in FIG. 3, an electronic device 120 may comprised a display 160 in the form of a touch screen input device 150-1. For example, the electronic device 120 may comprised a tablet computing device having a touch screen input device with 50 mobile applications (not shown) arranged on five application pages (not shown). According to existing technology, in order to access one of the 50 applications, a user may have to “swipe” or otherwise move through each page, scanning each one for the desired application. As shown in FIG. 3, navigation input 320 may comprise of user contact with the touch screen using an object, such as a human finger, in an empty area for a configurable, defined duration. The navigation input 320 may invoke the select-hold-release navigation menu 230-1 and display navigation elements 310.

The select-hold-release navigation menu 230-1 shown in FIG. 3 may be configured to display up to five navigation elements 310 at a time in positions P1-P5 rotating clockwise about the area of user input 320. The display sequence of the applications may be configured according to one or more ordering constructs, including, but not limited to, assigned cardinality (e.g., a favorites list), alphabetical order, date, most recently used, most frequently used, or combinations thereof. In the example embodiment of FIG. 3, the 50 applications may be ordered A1-A50. The select-hold-release navigation menu 230-1 may be initialized with application A1 coming into view at user interface position 316 into position P1. The first rotational interval may move A1 into P2 and A2 may come into view at user interface position 316 into P1. With the second rotational interval, A1 may move into P3, A2 may move into P2, and A3 may come into view at user interface position 316 into position P1. This sequence may repeat with each rotational interval until all of the positions P1-P5 have been filled, wherein A1 is in P5, A2 is in P4, A3 is in P3, A4 is in P2, and A5 is in P1. The next rotational interval may move A1 out of view at user interface position 314 and may move A6 into view at user interface position 316 and into P1. At this point in the rotational sequence, A2 is in P5, A3 is in P4, A4 is in P3, A5 is in P2, and A6 is in P1. This rotational process may be continued for each application and may repeat in a continuous, fluid motion while navigation input is maintained.

The select-hold-release navigation menu 230-1 may comprise a progress bar 330 configured to display the progress of navigation through the navigation elements 310 associated with the focus of navigation. In this manner, the select-hold-release navigation application 180 may indicate a potential duration for scrolling through all of the navigation elements 310 and progress associated therewith. In one embodiment, one or more sections of the progress bar 330 may be demarcated to indicate the location of certain navigation elements 310. For example, a location within the progress bar 330 may be highlighted 332 or otherwise designated to indicate the location of a particular navigation element 310 within all navigation elements 310, including, but not limited to, favorites, navigation element 310 last visited, most recently used, and most frequently used.

Release of the navigation input may stop rotation of the navigation elements 310 and the select-hold-release navigation menu may display the five navigation elements 310 visible when the navigation input was stopped as the selected navigation elements 240-f. A user may then select one of the five visible selected navigation elements 240-f. In one embodiment, the select-hold-release navigation menu 230-1 may comprise an active zone 312 configured to designate one of the navigation elements 310 as the selected navigation element 240-f. In this embodiment, the navigation element 310 located in the active zone 312 when the navigation input 320 is stopped may be the selected navigation element 240-f. The selected navigation element 240-f may be activated (e.g., the application associated with the navigation element is launched) responsive to the release of the navigation input 320.

Embodiments are not limited to the example configuration depicted in FIG. 3, as the select-hold-release navigation menu 230-1 presented therein is for illustrative purposes only. The embodiments are not limited in this context.

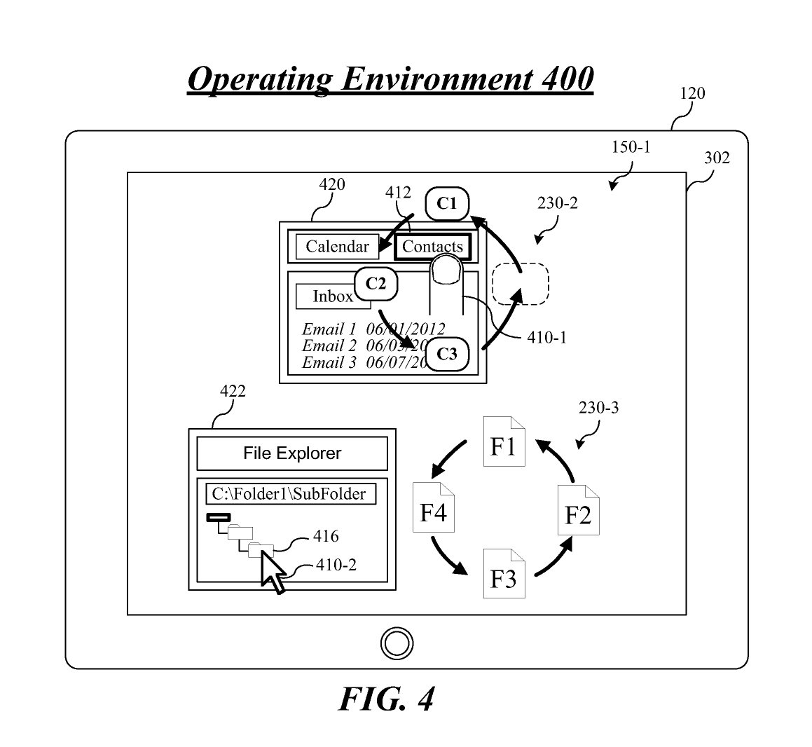

FIG. 4 illustrates an embodiment of an operating environment 400 for the select-hold-release navigation system 100. More particularly, the operating environment 400 may illustrate select-hold-release navigation menus 230-2, 230-3 presented on the display 160 of an electronic device 120.

In the illustrated embodiment shown in FIG. 4, electronic device applications 420, 422 may be configured to operate according to select-hold-release navigation as described according to embodiments provided herein. For example, an email application 420 may comprise a “Contacts” button 412 configured to display email contacts in a select-hold-release navigation menu 230-e. According to embodiments, the select-hold-release navigation application 180 may present a select-hold-release navigation menu 230-2 responsive to navigation input 410-1 at the “Contacts” button 412, wherein the navigation elements are comprised of email contacts C1-C3. In another example, a file explorer application 422 may be configured to provide access to files and folders stored on the electronic device 120. Embodiments provide that the select-hold-release navigation application 180 may present a select-hold-release navigation menu 230-2 responsive to navigation input 410-2 at a folder 416 being displayed in a file explorer application 422. As shown in FIG. 4, the navigation input 410-2 may comprise a mouse pointer selection. The select-hold-release navigation menu 230-2 may be configured to present files F1-F4 stored in the selected folder 416. The example embodiments depicted in FIG. 4 are illustrative and non-restrictive. The embodiments are not limited in this context.

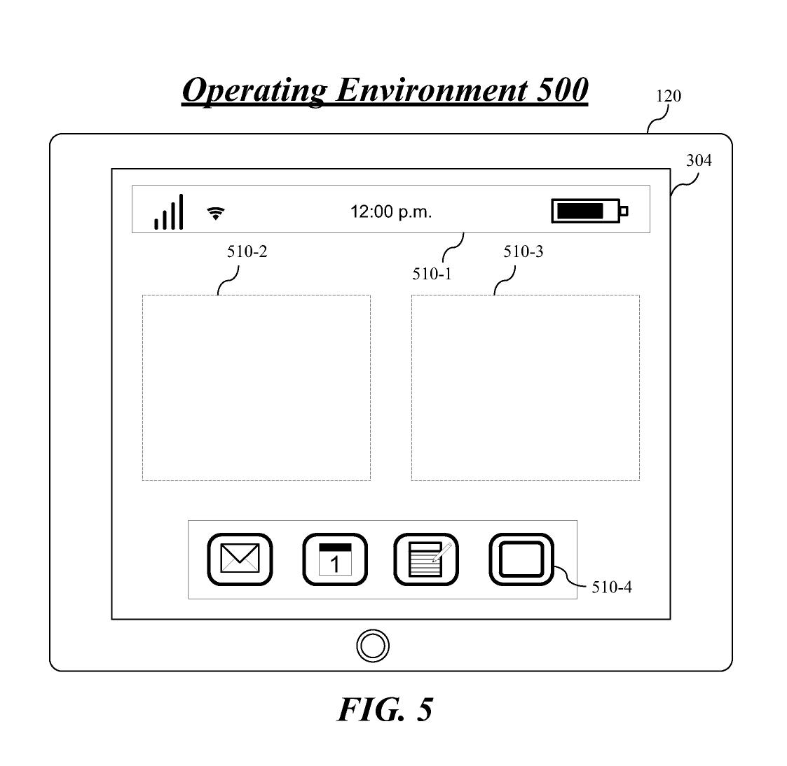

FIG. 5 illustrates an embodiment of an operating environment 500 for the select-hold-release navigation system 100. More particularly, the operating environment 500 may illustrate navigation zones 510-h accessible from the display 160 of an electronic device 120.

In the illustrated embodiment shown in FIG. 5, the select-hold-release navigation application 180 may be configured to differentiate navigation input 410-g based on navigation zones 510-h. According to embodiments, navigation input 410-g in a particular navigation zone 510-h may initiate a select-hold-release navigation menu 230-e. For example, navigation input 410-g in an electronic device operating information navigation zone 510-1 may invoke a select-hold-release navigation menu 230-e comprised of navigation elements 310 consisting of electronic device 120 settings applications (e.g., network settings, device operation settings, power settings). As shown in FIG. 5, areas of a user interface displayed by the display 160 may be divided into zones 510-2, 510-3. The select-hold-release navigation application 180 may be configured to display a select-hold-navigation menu 230-e specific for each zone 510-2, 510-3. For instance, zone 510-2 may be associated with a select-hold-navigation menu 230-e comprised of navigation elements 310 consisting of game applications installed on the electronic device 120. Zone 510-3, for example, may be associated with a select-hold-navigation menu 230-e comprised of navigation elements 310 consisting of productivity applications (e.g., email, word processing, spreadsheet, and file conversion applications) installed on the electronic device 120. In one embodiment, the select-hold-release navigation application 180 may be associated with an icon 510-4 that may be selected to trigger a select-hold-navigation menu 230-e. In this embodiment, user input 320 consisting of selection of the select-hold-release navigation icon 510-4 may immediately result in presentation of a select-hold-navigation menu 230-e without requiring that the user input 320 be sustained for a defined duration.

Embodiments are not limited to the example select-hold-navigation menu 230-e described for the configured zones 510-h. For example, zones 510-2, 510-3 may be associated with various types of select-hold-navigation menus 230-e, including, without limitation, menus associated with different tiers of navigation elements 310, navigation elements 310 grouped by a user, function, or usage.

In one embodiment, sustained user input may be used alone or in combination with other user input features to achieve electronic device security. For example, user input sustained for a defined period of time combined with a second user input gesture may be used as a password to gain access to the electronic device 120. For an electronic device 120 comprised of a touch screen input device 150-a, the user input may consist of a finger press on the touch screen input device 150-a for a configurable, defined duration accompanied, for example, by a finger roll or swipe gesture. In one embodiment, select-hold-release input 320 at a device lock screen may invoke a select-hold-release navigation menu 230-e configured to allow entry of a password. Embodiments are not limited in this context.

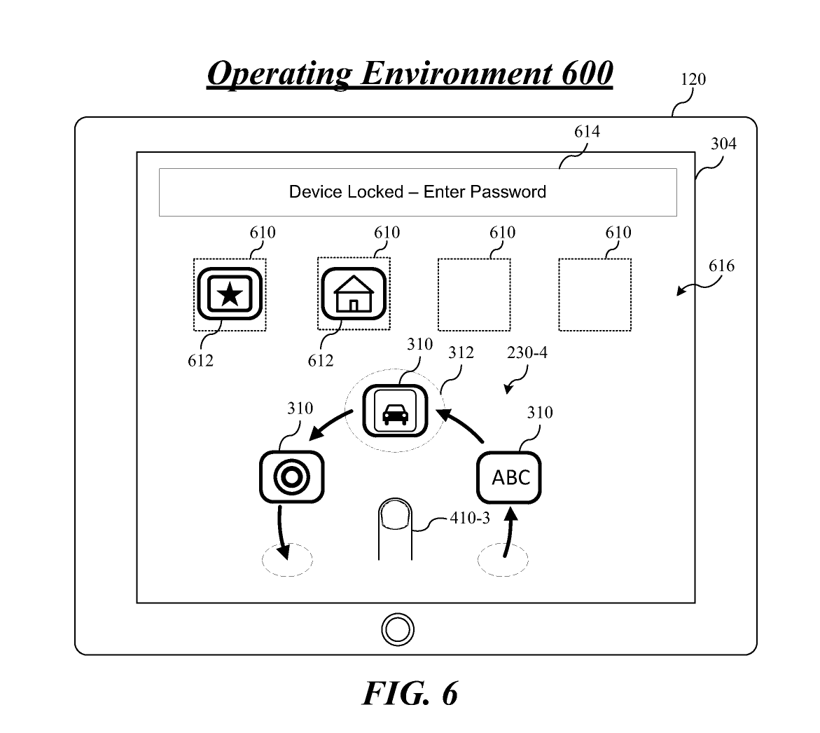

FIG. 6 illustrates an embodiment of an operating environment 600 for the select-hold-release navigation system 100. More particularly, the operating environment 600 may illustrate an aspect of authentication for an electronic device 120 implemented through select-hold-release navigation.

In the illustrated embodiment shown in FIG. 6, the select-hold-release navigation application 180 may be configured to implement certain aspects of security for an electronic device 120, such as device authentication. The electronic device 120 may be configured to be “locked” or to logout a user as is known to those having ordinary skill in the art. For example, the device may be locked or a user logged out responsive to a period of inactivity or a user command. When the electronic device 120 is in a locked or logged out state, a user may not operate the device nor access device elements, such as applications and files. The electronic device 120 may be unlocked or authenticated to according to certain processes, such as the entry of a password. According to certain embodiments, the password may be formulated as an ordered series of numeric, alphanumeric, symbolic, graphical (e.g., pictures, picture files), or combinations thereof, password elements. Before the device may be locked or a user logged out, the user may configure a password to be used to unlock or authenticate to the device. For example, a user may select an ordered series of pictures of a specified length that must be placed in the correct order to unlock or authenticate to the device. The pictures, or the location of the pictures, and the order thereof may be stored in secure storage on the electronic device 120 as the password.

As shown in FIG. 6, a select-hold-release navigation menu 230-4 may be utilized to enter a password to unlock electronic device 120. A user may be prompted to enter a password to unlock or authenticate to the device 614 from a device authentication user interface 616 that appears when input is detected at the electronic device 120 when it is locked or no user is logged in. A select-hold-release navigation menu 230-4 may appear responsive to navigation input 410-3 at the device authentication user interface 616. The select-hold-release navigation menu 230-4 comprises navigation elements 310 consisting of password elements that may be utilized to enter a password to unlock the electronic device 120. In the embodiment depicted in FIG. 6, the password consists of an ordered series of pictures. As such, the navigation elements 310 consist of pictures that may be utilized to create the password, which may include other pictures that are not part of the password. Embodiments are not limited to passwords consisting of picture password elements, as any type of password element that may operate consistent with the embodiments is contemplated herein. For example, the password may comprise numbers ranging from 0-9 and the actual password may be 0123. In this example, the navigation elements 310 may consist of all of the numbers in the range 0-9, even though the actual password does not use all of the numbers in that range.

When the navigation input 410-3 is released, the selected navigation element 310 may be placed in the next empty password element slot 610. In one embodiment, the navigation element 310 in the active zone 312 at the time of navigation input 410-3 release may be put in the next empty password element slot 610. In another embodiment, the navigation elements 310 visible when the navigation input 410-3 is released may remain on the screen for selection by a user and placement into the next empty password slot 610. Once selected, the navigation element 310 may be placed in a password slot 610 as a selected password element 612. If the user generates the correct password, the electronic device 120 may be unlocked; otherwise, the device remains locked.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

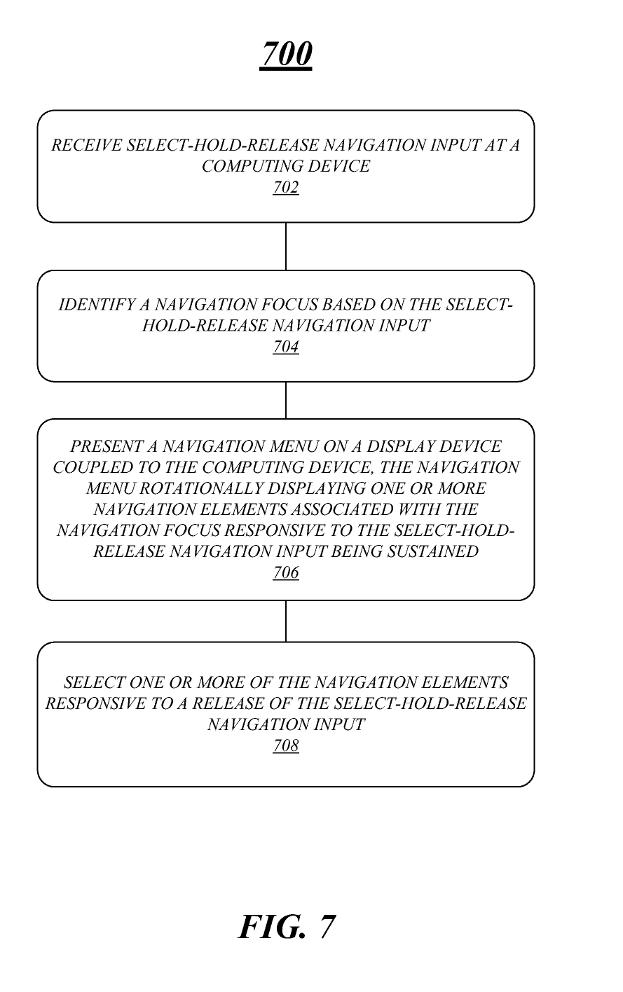

FIG. 7 illustrates one embodiment of a logic flow 700. The logic flow 700 may be representative of some or all of the operations executed by one or more embodiments described herein. For example, the logic flow 700 may illustrate operations performed by the select-hold-release navigation system 100.

In the illustrated embodiment shown in FIG. 7, the logic flow 700 may receive navigation input at a computing device at block 702. For example, the navigation identifier component 210-1 may monitor user input for input indicative of navigation input 410-g. In one embodiment, navigation input 410-g may comprise user input sustained for a defined duration. In another embodiment, navigation input 410-g may comprise primary and a secondary user input, either simultaneously or in combination. For an electronic device housing a touch screen input device, the primary input may be contact by a first object, while secondary input may be contact by a second object. For instance, a user may press a first finger on the touch screen and tap on the touch screen with a second finger to generate navigation input 410-g. According to embodiments, the type and method of navigation input 410-g may be user configurable, for example, through settings defined in an electronic device operating system or the select-hold-release navigation application 180.

In the illustrated embodiment shown in FIG. 7, the logic flow 700 may identify a navigation focus based on the navigation input at block 704. For example, the navigation identifier component 210-1 may determine a focus of navigation based on the location of navigation input 410-g. In one embodiment, if the location of navigation input 410-g is an empty area of a user interface, then the focus of navigation may consist of applications installed on the electronic device 120. In another embodiment, a user interface may be divided into navigation zones 510-h, each associated with a navigation focus, such as groups of applications or an ordering structure of navigation elements 310.

In the illustrated embodiment shown in FIG. 7, the logic flow 700 may present a navigation menu on a display device coupled to the computing device, the navigation menu rotationally displaying one or more navigation elements associated with the navigation focus responsive to the navigation input being sustained at block 706. For example, the navigation display component 210-2 may present a navigation menu 230-e comprising one or more navigation elements 310 displayed in a rotating manner. In one embodiment, the select-hold-release navigation menu 230-e may be configured to rotate and interchange the navigation elements 310 as the navigation elements 310 appear to rotate in and out of a user interface displayed on a display 160.

In the illustrated embodiment shown in FIG. 7, the logic flow 700 may select one or more of the navigation elements responsive to a release of the navigation input at block 708. For example, the navigation selector component 210-3 may select one or more of the navigation elements 310 being displayed on the select-hold-release navigation menu 230-e when the navigation input 410-g is removed. Selection of navigation elements 310 may be configured in various ways in the select-hold-release navigation application 180. For instance, selection may comprise activating a particular navigation element 310, displaying one or more navigation elements 310, displaying one or more other select-hold-release navigation menus 230-e, changing the navigation focus of the select-hold-release navigation menus 230-e, or changing the ordering structure of the navigation elements 310.

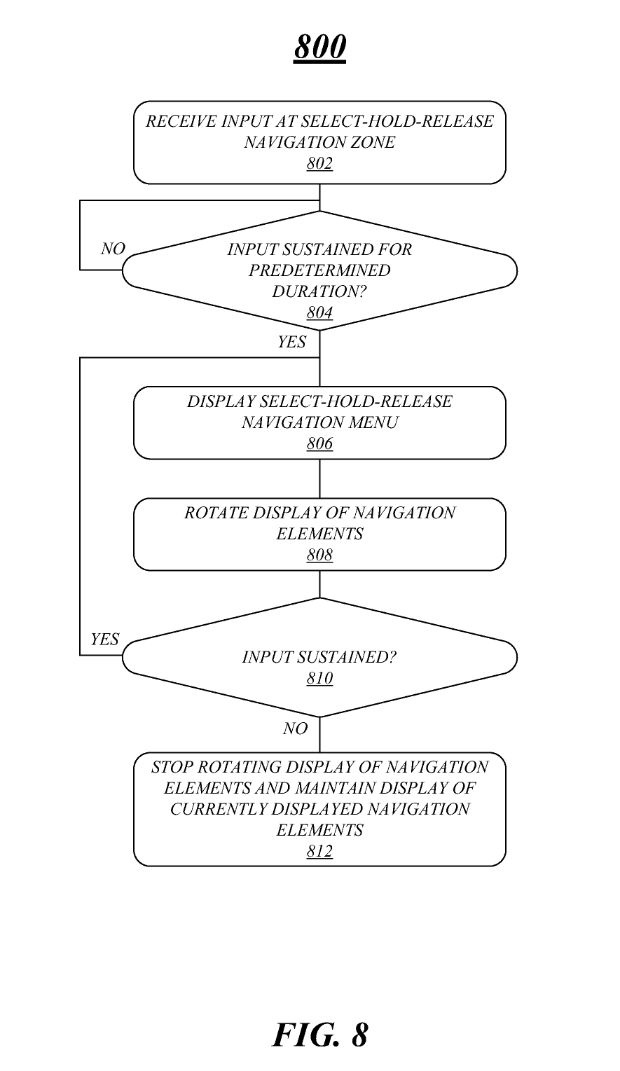

FIG. 8 illustrates one embodiment of a logic flow 800. The logic flow 800 may be representative of some or all of the operations executed by one or more embodiments described herein. For example, the logic flow 800 may illustrate operations performed by the select-hold-release navigation system 100.

In the illustrated embodiment shown in FIG. 8, the logic flow 800 may receive input at a select-hold-release navigation zone at block 802. For example, the navigation identifier component 210-1 may receive user input at a navigation zone 510-h.

The logic flow 800 may determine whether the input is sustained for a defined duration at decision block 804. For example, the navigation identifier component 210-1 may monitor user input to determine whether it has been sustained for a defined amount of time as configured in the select-hold-release navigation application 180. If the user input has been sustained for the defined amount of time, the navigation identifier component 210-1 may classify the user input as navigation input 320.

The logic flow 800 may display a select-hold-release navigation menu at block 806. For example, the navigation identifier component 210-1 may identify the focus of navigation based on the location of the navigation input 320. The focus of navigation information may be communicated to the navigation menu display component 210-2, which may display a select-hold-release navigation menu 230-e comprised of navigation elements 310 associated with the focus of navigation.

The logic flow 800 may rotate the display of navigation elements at block 808. For example, the navigation menu display component 210-2 may rotate the navigation elements 310 being displayed on the display 160. As the navigation elements 310 are rotated, embodiments provide the navigation menu display component 210-2 may interchange the displayed navigation elements 310 according to one or more ordering structures.

The logic flow 800 may monitor whether the input is sustained at decision block 810. For example, the navigation menu display component 210-2 may continue to display the select-hold-release navigation menu 230-e, including the rotation of navigation elements 310, while the navigation input 320 is being sustained at the electronic device 120.

The logic flow 800 may stop rotating the display of navigation elements and maintain the display of currently displayed navigation elements at block 812. For example, the navigation menu display component 210-2 may stop the rotation of navigation elements 310 responsive to the release of navigation input 320 as determined in decision block 810. The navigation selector component may select the navigation elements 310 select that were being displayed at the time of navigation input 320 release for display on the display device 160. A user may then select one of the selected navigation elements 310.

FIG. 9 illustrates an embodiment of an exemplary computing architecture 900 suitable for implementing various embodiments as previously described. In one embodiment, the computing architecture 900 may comprise or be implemented as part of an electronic device 120.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors, such as those described with reference to the processor circuit 130 shown in FIG. 1.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 900 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 100.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

FIG. 10 illustrates a block diagram of an exemplary communications architecture 1000 suitable for implementing various embodiments as previously described. The communications architecture 1000 includes various common communications elements, such as a transmitter, receiver, transceiver, radio, network interface, baseband processor, antenna, amplifiers, filters, power supplies, and so forth. The embodiments, however, are not limited to implementation by the communications architecture 1000.

As shown in FIG. 10, the communications architecture 1000 comprises includes one or more clients 1002 and servers 1004. The clients 1002 may implement the client device 2310. The servers 1004 may implement the server device 1050. The clients 1002 and the servers 1004 are operatively connected to one or more respective client data stores 1008 and server data stores 1010 that can be employed to store information local to the respective clients 1002 and servers 1004, such as cookies and/or associated contextual information.

The clients 1002 and the servers 1004 may communicate information between each other using a communication framework 1006. The communications framework 1006 may implement any well-known communications techniques and protocols. The communications framework 1006 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1006 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1002 and the servers 1004. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the select-hold-release navigation system 100 as previously described with reference to FIGS. 1-10 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments; examples one through forty-three (1-43) provided below are intended to be exemplary and non-limiting.

In a first example, a computer-implemented method comprises receiving a navigation input; identifying a navigation focus based on the navigation input; presenting a navigation menu on a display device coupled to a computing device, the navigation menu rotationally displaying one or more navigation elements associated with the navigation focus for a duration of the navigation input; and selecting one or more of the navigation elements responsive to a release of the navigation input.

A second example comprises the method described in the first example, the navigation input comprising control directives generated by an input device sustained for a defined duration.

A third example comprises the computer-implemented method described in the second example, the navigation input comprising control directives generated by an input device being associated with a navigation capable area.

A fourth example comprises the computer-implemented method described in the third example, the input device comprising a touch screen input device operative to generate control directives responsive to receiving touch input.

A fifth example comprises the computer-implemented method described in the fourth example, further comprising identifying the navigation focus based on a location of the navigation input within a user interface presented on the display device.

A sixth example comprises the computer-implemented method described in the fifth example, the location comprising a defined area of the user interface.

A seventh example comprises the computer-implemented method described in the fifth example, the location comprising one or more navigation zones of the user interface.

An eighth example comprises the computer-implemented method described in the fifth example, the location comprising one or more application objects.

A ninth example comprises the computer-implemented method described in the first example, the navigation focus comprising applications installed on the computing device.

A tenth example comprises the computer-implemented method described in the first example, the navigation focus comprising application elements associated with an application installed on the computing device.

An eleventh example comprises the computer-implemented method described in the first example, the navigation focus comprising a device authentication user interface for the computing device, the device authentication user interface to receive a password comprising one or more password elements to authenticate to the computing device via the navigation menu.

A twelfth example comprises the computer-implemented method described in the eleventh example, the one or more navigation elements comprising the password elements.

A thirteenth example comprises the computer-implemented method described in the twelfth example, the password elements comprising picture objects.

A fourteenth example comprises the computer-implemented method described in the twelfth example, further comprising receiving a password element as a portion of the password responsive to selection of the password element selected via a release of the navigation input.

A fifteenth example comprises the computer-implemented method described in the first example, further comprising presenting a subset of the one or more navigation elements in the navigation menu.

A sixteenth example comprises the computer-implemented method described in the first example, further comprising interchanging the one or more navigation elements as the navigation elements rotate.

A seventeenth example comprises the computer-implemented method described in the first example, comprising rotating the navigation elements presented in the navigation menu in a motion forming a virtual vortex appearing to move in and out of the display device.

An eighteenth example comprises the computer-implemented method described in the first example, wherein selecting one or more of the navigation elements comprises selecting an active element responsive to the release of the navigation input.

A nineteenth example comprises the computer-implemented method described in any of the first to eighteenth examples, wherein selecting one or more of the navigation elements comprises displaying navigation elements visible during the release of the navigation input.

A twentieth example comprises the computer-implemented method described in any of the first to eighteenth examples, further comprising presenting the one or more navigation elements in the navigation menu based on one or more information indexes associated with the navigation focus.

In a twenty-first example, at least one machine-readable storage medium comprises a plurality of instructions that in response to being executed on a computing device, cause the computing device to carry out a method according to any of the first to eighteenth examples.

In a twenty-second example, an apparatus comprises a means for performing the computer-implemented method of any of the first to eighteenth examples.

In a twenty-third example, an apparatus comprises a transceiver; a processor circuit coupled to the transceiver; and a memory unit coupled to the processor circuit, the memory unit to store a select-hold-release navigation application, the select-hold-release navigation application operative on the processor circuit to present a navigation menu rotationally displaying one or more navigation elements based on navigation input received at the apparatus, the navigation input comprising control directives generated by an input device coupled to the apparatus sustained for a defined duration and being associated with a navigation capable area.

A twenty-fourth example comprises the apparatus described in the twenty-third example, the select-hold-release navigation application comprising a navigation identifier component operative to receive the navigation input, and identify a navigation focus based on the navigation input.

A twenty-fifth example comprises the apparatus described in the twenty-fourth example, the select-hold-release navigation application comprising a navigation menu display component operative to present the navigation menu on a display device coupled to the apparatus, the navigation menu rotationally displaying one or more navigation elements associated with the navigation focus for a duration of the navigation input.

A twenty-sixth example comprises the apparatus described in the twenty-fifth example, the select-hold-release navigation application comprising a navigation selector component operative to select one or more of the navigation elements responsive to a release of the navigation input.

A twenty-seventh example comprises the apparatus described in the twenty-sixth example, the navigation identifier component operative to receive control directives generated at a touch screen input device coupled to the apparatus, the control directives generated responsive to the touch screen input device receiving touch input.

A twenty-eighth example comprises the apparatus described in the twenty-sixth example, the navigation identifier component operative to identify the navigation focus based on a location of the navigation input within a user interface presented on the display device.

A twenty-ninth example comprises the apparatus described in the twenty-eighth example, the location comprising a defined area of the user interface.

A thirtieth example comprises the apparatus described in the twenty-eighth example, the location comprising one or more navigation zones of the user interface.

A thirty-first example comprises the apparatus described in the twenty-eighth example, the location comprising one or more application objects.

A thirty-second example comprises the apparatus described in the twenty-sixth example, the navigation focus comprising applications installed on the apparatus.

A thirty-third example comprises the apparatus described in the twenty-sixth example, the navigation focus comprising application elements associated with an application installed on the apparatus.

A thirty-fourth example comprises the apparatus described in the twenty-sixth example, the navigation focus comprising a device authentication user interface for the computing device, the device authentication user interface to receive a password comprising one or more password elements to authenticate to the computing device via the navigation menu.

A thirty-fifth example comprises the apparatus described in the thirty-fourth example, the one or more navigation elements comprising the password elements.

A thirty-sixth example comprises the apparatus described in the thirty-fifth example, the password elements comprising picture objects.

A thirty-seventh example comprises the apparatus described in the thirty-fifth example, the navigation selector component operative to receive a password element as a portion of the password responsive to selection of the password element selected via a release of the navigation input.

A thirty-eighth example comprises the apparatus described in the twenty-sixth example, the navigation menu display component operative to display a subset of the one or more navigation elements in the navigation menu.

A thirty-ninth example comprises the apparatus described in the twenty-sixth example, the navigation menu display component operative to interchange the one or more navigation elements as the navigation elements rotate in the navigation menu.

A fortieth example comprises the apparatus described in the twenty-sixth example, the navigation menu display component operative to present the navigation menu as rotating the navigation elements in a motion forming a virtual vortex appearing to move in and out of the display device.

A forty-first example comprises the apparatus described in the twenty-sixth example, the navigation selector component operative to select one or more of the navigation elements, wherein to select comprises selecting an active element responsive to the release of the navigation input.

A forty-second example comprises the apparatus described in any of the twenty-sixth to forty-first examples, the navigation selector component operative to select one or more of the navigation elements, wherein to select comprises displaying navigation elements visible during the release of the navigation input.

A forty-third example comprises the apparatus described in any of the twenty-sixth to forty-first examples, the navigation menu display component operative to present the navigation menu displaying the one or more navigation elements based on one or more information indexes associated with the navigation focus.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1-43. (canceled)

44. A computer-implemented method comprising:
receiving a navigation input;
identifying a navigation focus based on the navigation input;
presenting a navigation menu on a display device coupled to a computing device, the navigation menu rotationally displaying one or more navigation elements associated with the navigation focus for a duration of the navigation input; and
selecting one or more of the navigation elements responsive to a release of the navigation input.

45. The computer-implemented method of claim 44, the navigation input comprising control directives generated by an input device sustained for a defined duration.

46. The computer-implemented method of claim 45, the navigation input comprising control directives generated by an input device being associated with a navigation capable area.

47. The computer-implemented method of claim 46, the input device comprising a touch screen input device operative to generate control directives responsive to receiving touch input.

48. The computer-implemented method of claim 44, further comprising identifying the navigation focus based on a location of the navigation input within a user interface presented on the display device.

49. The computer-implemented method of claim 44, the navigation focus comprising applications installed on the computing device.

50. The computer-implemented method of claim 44, further comprising interchanging the one or more navigation elements as the navigation elements rotate.

51. The computer-implemented method of claim 44, further comprising rotating the navigation elements presented in the navigation menu in a motion forming a virtual vortex appearing to move in and out of the display device.

52. The computer-implemented method of claim 44, wherein selecting one or more of the navigation elements comprises displaying navigation elements visible during the release of the navigation input.

53. The method of claim 44, further comprising presenting the one or more navigation elements in the navigation menu based on one or more information indexes associated with the navigation focus.

54. An apparatus, comprising:
a transceiver;
a processor circuit coupled to the transceiver; and
a memory unit coupled to the processor circuit, the memory unit to store a select-hold-release navigation application, the select-hold-release navigation application operative on the processor circuit to present a navigation menu rotationally displaying one or more navigation elements based on navigation input received at the apparatus, the navigation input comprising control directives generated by an input device coupled to the apparatus sustained for a defined duration and associated with a navigation capable area.

55. The apparatus of claim 54, the select-hold-release navigation application comprising a navigation identifier component operative to receive the navigation input, and identify a navigation focus based on the navigation input.

56. The apparatus of claim 55, the select-hold-release navigation application comprising a navigation menu display component operative to present the navigation menu on a display device coupled to the apparatus, the navigation menu rotationally displaying one or more navigation elements associated with the navigation focus for a duration of the navigation input.

57. The apparatus of claim 55, the select-hold-release navigation application comprising a navigation selector component operative to select one or more of the navigation elements responsive to a release of the navigation input.

58. The apparatus of claim 57, the navigation identifier component operative to receive user input comprising touch input received at a touch screen input device coupled to the apparatus.

59. The apparatus of claim 57, the navigation identifier component operative to identify the navigation focus based on a location of the navigation input within a user interface displayed on the display device.

60. The apparatus of claim 57, the navigation identifier component operative to receive control directives generated at a touch screen input device coupled to the apparatus, the control directives generated responsive to the touch screen input device receiving touch input.

61. The apparatus of claim 57, the navigation identifier component operative to identify the navigation focus based on a location of the navigation input within a user interface presented on the display device.

62. The apparatus of claim 61, the location comprising a defined area of the user interface.

63. The apparatus of claim 57, the navigation focus comprising a device authentication user interface for the apparatus, the device authentication user interface to receive a password comprising one or more password elements to authenticate to the apparatus via the navigation menu

64. The apparatus of claim 57, the navigation menu display component operative to interchange the one or more navigation elements as the navigation elements rotate in the navigation menu.

65. The apparatus of claim 57, the navigation menu display component operative to present the navigation menu as rotating the navigation elements in a motion forming a virtual vortex appearing to move in and out of the display device.

66. At least one computer-readable storage medium comprising instructions that, when executed, cause a system to:
receive a navigation input;
identify a navigation focus based on the navigation input;
present a navigation menu on a display device coupled to the system, the navigation menu rotationally displaying one or more navigation elements associated with the navigation focus for a duration of the navigation input; and
select one or more of the navigation elements responsive to a release of the navigation input.

67. The computer-readable storage medium of claim 66, the navigation input comprising control directives generated by an input device sustained for a defined duration.

68. The computer-readable storage medium of claim 67, the input device comprising a touch screen input device operative to generate control directives responsive to receiving touch input.

69. The computer-readable storage medium of claim 66, comprising instructions that when executed cause the system to identify the navigation focus based on a location of the navigation input within a user interface presented on the display device.

70. The computer-readable storage medium of claim 69, the location comprising a defined area of the user interface.

71. The computer-readable storage medium of claim 66, the navigation focus comprising applications installed on the system.

72. The computer-readable storage medium of claim 66, comprising instructions that when executed cause the system to interchange the one or more navigation elements as the navigation elements rotate.

73. The computer-readable storage medium of claim 66, comprising instructions that when executed cause the system to rotate the navigation elements presented in the navigation menu in a motion forming a virtual vortex appearing to move in and out of the display device.

74. The computer-readable storage medium of claim 66, comprising instructions that when executed cause the system to select one or more of the navigation elements, wherein selecting one or more of the navigation elements comprises displaying navigation elements visible during the release of the navigation input.

75. The computer-readable storage medium of claim 66, comprising instructions that when executed cause the system to display the one or more navigation elements based on one or more information indexes associated with the navigation focus.
